(19) United States
(12) Patent Application Publication
(10) Pub. No.: US 2006/0159827 A1
(43) Pub. Date: Jul. 20, 2006

(54) Flower shape made of coffee

(76) Inventor: Young Ok Ha, Gyunggi-do (KR)

Correspondence Address: J C Patents Inc, Suite 250, 4 Venture, Irvine, CA, 92618, US

(21) Appl. No.: 10/563,163

(22) PCT Filed: Jun. 26, 2004
(86) PCT No.: PCT/KR04/01566

§ 371 Date: Dec. 27, 2005

(30) Foreign Application Priority Data
Jun. 27, 2003 (KR) 20-2003-0020493
Feb. 16, 2004 (KR) 10-2004-0010192

(51) Int. Cl. A23F 5/00

(52) U.S. Cl. 426/594

(57) ABSTRACT

The present invention relates to a method and pattern structure by which various kinds of patterns are made using coffee or flower. A certain amount of coffee is ground using a grinder, and various kinds of shapes such as tree leaves and flowers are made using coffee through multiple processes. When mixing coffee with water in a coffee cup, a flower shaped coffee is inserted into the cup rather than conventionally inserting coffee grains, for thereby enhancing a good feeling. It is possible to satisfy various trends of modern people.

### TECHNICAL FIELD

The present invention relates to a fabrication method and pattern structure of coffee by which various kinds of patterns are made using coffee or flower, and in particular to a flower shape made of coffee implemented in such a manner that a certain amount of bean is parched at 180° C. through 200° C. and is ground to powder using a grinder. The powder is inputted into an evaporator with vacuum, and hot water and coffee powder are mixed at a ratio of 4:1. When the total amount is decreased to ⅔, a resultant mixture is inputted into a wide and shallow container and is frozen in a freezer. The frozen mixture is taken out and is formed using a press machine in a flower or a certain shape. The resultant structure is frozen at a lower temperature and is evaporated in a vacuum drier.

### BACKGROUND ART

A conventional instant coffee does not have a certain design or shape not in a beautiful shape. In the above state, coffee is mixed with water using a teaspoon. Namely, the conventional coffee is used only in such a manner that it is inputted into water and is mixed.

The conventional coffee is parched for 15 minutes at 180° and is ground and inputted into an evaporator with vacuum, and ground coffee is mixed with water at a ration of 4:1. When the total amount of the same is decreased to ⅔, it is applied on a wide and shallow plate. The resultant mixture is frozen at 40° C. and is taken out from the container and is ground and evaporator for thereby fabricating a typical coffee.

### BRIEF DESCRIPTION OF THE DRAWINGS

The preferred embodiments of the present invention will be described with reference to the accompanying drawings.

FIG. 1 is a picture of coffee according to the present invention;

FIG. 2 is a cross sectional view of coffee powder according to the present invention;

FIG. 3 is a perspective of a candy made of coffee according to a first embodiment of the present invention;

FIG. 4 is a perspective view of various structures made of coffee according to another embodiment of the present invention;

FIGS. 5 through 8 are cross sectional views of various structures made of coffee according to another embodiment of the present invention;

FIG. 9 is a cross sectional view illustrating a circular structure according to another embodiment of the present invention;

FIG. 10 is a cross sectional view illustrating a container capable of making a petal using coffee according to the present invention;

FIG. 11 is a perspective view illustrating a big container capable of making a 3D coffee structure (FIG. 4) according to the present invention;

FIG. 12 is a perspective view illustrating a container used for flattening a coffee structure in a container (FIG. 11) smaller than that of FIG. 11 according to the present invention in which the container is made smaller than the big container (FIG. 11), and a coffee mixture is applied in a flat shape in the container;

FIG. 13 is a view illustrating a mold placed on a coffee extract formed in a flower leave before it is pressed using a press machine according to the present invention;

FIG. 14 is a view illustrating a mold needed for forming a certain shape using coffee and a mold placed on a coffee extract before it is pressed using a press machine according to the present invention;

FIG. 15 is a view illustrating a seal capable of forming a pattern on a frozen extract coffee according to the present invention; and

FIG. 16 is a view illustrating an operation that a mold is placed on a frozen coffee, and a certain shape is made using a press machine.

### DISCLOSURE OF INVENTION

Accordingly, it is an object of the present invention to overcome the problems encountered in the conventional art.

Sublimation means that frozen coffee is inputted into a drier, and heat is supplied thereto. At this time, the frozen is coffee with moisture is melted. Therefore, it is needed to dry the frozen coffee in a vacuum state for thereby maintaining an original shape.

In the process for fabricating coffee, it is possible to adjust the ratio of water and coffee, the temperature and ratio of heating coffee, the size of coffee powder, the time and concentration and temperature needed for evaporating the coffee in the evaporator, the temperature and time of a freezer, the pressure and temperature of evaporator and drier, the concentration and ratio of the extract liquid, the amount of moisture when finishing the same, the parching temperature and time.

The present invention is basically directed to fabricating coffee in a shape of a petal of FIG. 5, a tree leave of FIG. 7, a candy shape of FIG. 3 and other beautiful petals, not in a random shape or broken shape like in a conventional coffee.

In the present invention, there are provided a flower shape of FIG. 5, a tree leave shape of FIGS. 7 and 8, a candy shape of FIG. 3, and other shapes using coffee.

The method of achieving the present invention will be described in detail.

Coffee is parched at a temperature of 180° C. through 200° C. for 15 minutes and is fast cooled. The coffee is ground using a grinder and is mixed with hot water at a ratio of 4:1. The coffee is inputted into the evaporator and is vaporized to get to decrease to a decreased amount of ⅔ as compared to the original amount. The resultant coffee is applied in a thin shape on a flat container and then is slightly frozen using a freezer. The frozen coffee is taken out from the container and is pressed by a press machine in a flower shape of FIG. 5. The frozen coffee pressed in a certain shape gets to be inputted into the container of FIG. 10 and is dried in a drying step. In another step, the resultant coffee comes out of the container and is pressed using a press machine in a multiple layer.

Thereafter, the coffee is frozen at a temperature below zero of 40° C. for 10 minutes and is dried in a vacuum drier. The drying process is performed in the drier by a weak fire with a pressure of 80%, gradually decreasing moisture. It lasts for about 8 hours. When the coffee is finished, it is dried with moisture of about 5%.

When the frozen coffee is pressed using a pressing machine, the molds of FIG. 13 are made, corresponding to the shapes of FIGS. 5 through 9, and the molds are inserted between coffee and press machine.

After the coffee is parched, it is cooled at a temperature under zero for the reason of maintaining the perfumes of coffee that may disappear due to the hot heat.

The coffee with the 3D shape is fabricated in a method similar to the above method. Namely, the pressing step is omitted. The coffee is inserted into the container of FIG. 11 and is dried and dried in a frozen state. The coffee powder is inputted into the container, and a previously made lid is covered after the coffee liquid is inputted. A drying step is performed.

### BEST MODE FOR CARRYING OUT THE INVENTION

The preferred embodiments of the coffee pattern structure according to the present invention will be described with reference to the accompanying drawings.

The present invention is directed to a method in which coffee is made in various shapes, not in a random shape or a broken shape.

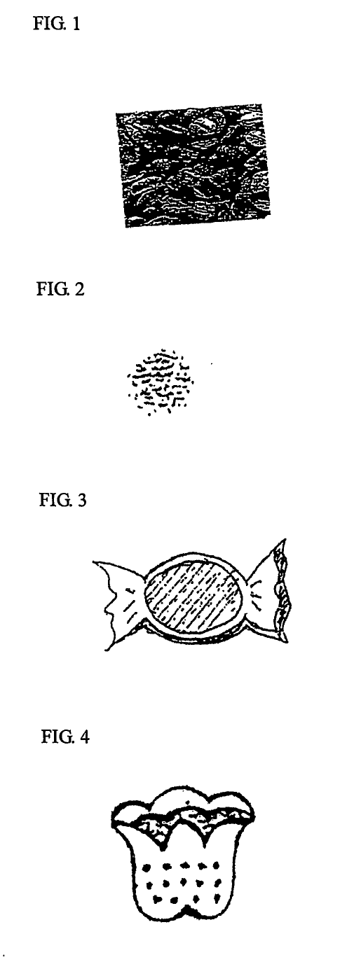

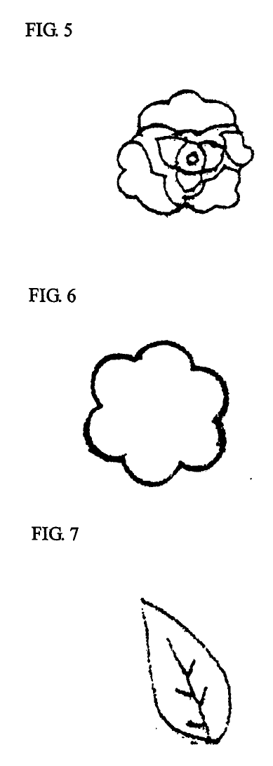

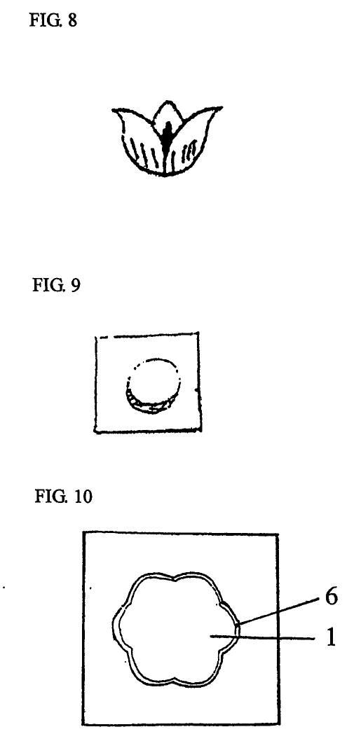

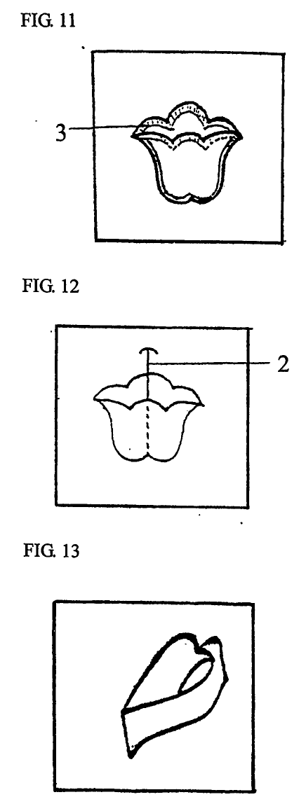

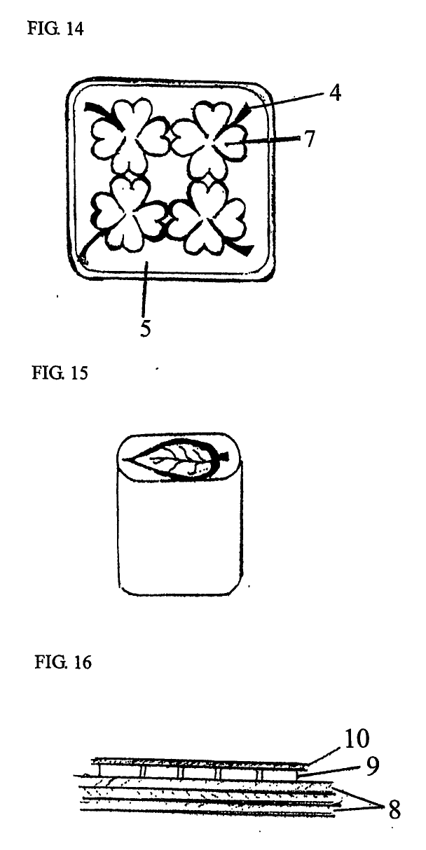

As shown in the attached drawings, a certain amount of coffee of FIG. 1 is inserted into a wide container and is parched at 180° C. through 200° C. for 15 minutes, and is cooled at a temperature under zero. The coffee is ground using a grinding machine, and the coffee is mixed with water at a ratio of 1:4 and is evaporated by a weak fire for 30 minutes in an evaporator of vacuum. At this time, the pressure of the evaporator is below or above 80%. When the amount of coffee is decreased to ⅔, thick coffee is fabricated. The coffee is inserted into a smaller container of FIGS. 10 and 14 and is frozen in a freezer and is evaporated in a driver. The coffee is taken out of the container and is dried. In another method, the coffee extract liquid is thinly applied on the flat container and is frozen and taken out of the container. The frozen coffee is inserted into the press machine, and the shapes of FIGS. 5 through 9 are made. At this time, a single layer or multiple layers could be pressed. Next, it is frozen in a freezer at a temperature under zero of 40° C. for 10 minutes. The coffee is dried in a drier. A weak fire is used for drying the coffee. The pressure of the drier with vacuum is 80%, and the sublimation (dry) step is performed for about 8 hours. The finished coffee is hard and has moisture of about 5%.

As the coffee fabrication technique is advanced, a condenser is generally used for keeping the perfume of coffee maintained when evaporating the coffee in the evaporator. In detail, when the vapor including hot coffee perfume outputted from the evaporator and the drier contacts with the cool member, it is changed to liquid. When the liquid is frozen, for thereby achieving a solid. The resultant mixture is mixed, so that frozen dried coffee is finished.

The frozen dried coffee fabrication steps are shown in FIGS. 3, 5, 6, 7, 8, 9 and 14. The coffee could be made in the shapes of the same.

The shapes of the coffee extract liquid are made, so that it is possible to freely fabricate various shapes of coffee. More containers (FIGS. 10 and 13 through 14) may be further used for thereby enhancing an efficiency of the fabrication.

The frozen coffee extract liquid may be pressed in the container when pressing using the press machine or may be taken out of the container and then may be pressed.

The fabrication processes of the drier and the evaporator are performed in a vacuum state.

Water is sprayed in the bottom and lateral sides of the container before the coffee extract liquid is inputted into the container of FIGS. 10 and 11 for the reason that the coffee could be well taken out after it is dried. In addition, when shaping the coffee of FIGS. 4 through 9, a smaller container is used. There are two methods for drying the coffee in the container. Namely, the coffee extract liquid is inserted therein and frozen and is taken out of the container and then is dried. In the case of the plane views of FIGS. 5 through 9, a mold corresponding to a desired mold of FIG. 13 is made and is placed on the frozen coffee extract liquid and is pressed using the press machine. When pressing the coffee, it is applied in a flat shape and is pressed in a state that the coffee is slightly frozen.

At this time, the press machine is not limited thereto. A mold of FIG. 13 having a certain shape is made when pressing the shapes of the coffee. The mold is placed on the coffee, so that a desired shape is made as shown in FIGS. 5 through 10 and FIG. 14.

In the instant coffee fabrication process, a little bit amount of sugar, milk, or cream may be freely added to the coffee. In addition, a certain food additive may be added based on the customer's taste.

In the instant coffee fabrication process, it is possible to freely adjust the size of the coffee powder, the parching temperature and time of coffee, a ratio of water and coffee, a ratio of the coffee vaporization time, the time, pressure and temperature of the vaporizer and drier, the temperature and time of the freezer, the drying time, the amount of remaining moisture, a concentration ratio of the coffee extract liquid, the heating temperature of coffee, the concentration of the coffee extract liquid, the container adaptation method and other methods.

FIG. 1 is a coffee picture.

FIG. 2 is a cross sectional view of the powder of coffee. The coffee is parched at 180° C. through 200° C. for 15 minutes. The coffee is cooled at a temperature under zero and is well ground using a grinder, thus generating fine powder. At this time, the size of the coffee is generally 1.5 mm. FIG. 3 is a perspective view of a coffee candy. The candy contains coffee. Here, sugar, cinnamon powder, solid milk powder, etc. may be contained. Like the candy fabrication process, it may be fabricated in a round shape of FIG. 3, a cylindrical shape of FIG. 9 or a certain shape.

FIG. 4 is a view of a 3D shape in which coffee powder is contained in a petal. The extract liquid is thinly applied on the container of FIG. 11 in order to form a flow shape of an outer look of FIG. 11 and is frozen. Water is slightly sprayed on the container before the extract liquid is inserted into the container of FIG. 11 and is applied on the container in a shape of the container. The coffee powder of FIG. 2 or a typical instant coffee is inserted into the round groove of FIG. 11. A previously prepared lid of FIG. 6 is covered, and the coffee is dried in the drier.

The coffee extract liquid is inserted into a large container of FIG. 11, and a smaller container of FIG. 12 is inserted into the large container of FIG. 11 for thereby reforming the shape. The coffee is frozen at a temperature under zero of 40° C. for 10 minutes and is dried in the drier with vacuum. At this time, the outer construction of the flower shape of FIG. 4 is dried, and the coffee powder may be inserted in a frozen state.

When the coffee extract liquid is applied, since it is sticky, the extract liquid is applied in a slightly frozen state, for thereby preventing sticky.

At this time, when the coffee lid of FIG. 6 is attached, a hot coffee extract liquid is slightly applied on the marginal portion. In addition, the coffee extract liquid is inserted into the container of FIG. 11, and the coffee liquid is stored therein and frozen and dried without using an outer container of FIG. 12. When the coffee is inserted into the container of FIG. 11 and is frozen, the coffee is uniformly slightly applied on the upper side, so that it is possible to directly dry. At this time, it is not needed to separately insert the coffee powder.

In the coffee design, various designs are not limited to the designs of FIGS. 3 through 9 and FIG. 14. Slightly streamline shapes may be adapted, not plane shape. FIGS. 5 through 8 are views of various plane shapes, not 3D. Various shapes may be possible. FIG. 9 is a view of a portable circular shape made of coffee. When driving a car, it is possible to prevent sleepiness. The fabrication process is the same as the above. In this embodiment of the present invention, the thickness may be slightly increased.

In the coffee fabrication, the shapes are pressed using a press machine. Namely, the shapes may be formed as shown in FIGS. 3 through 9, and the coffee is dried in the vacuum state. In another method, the shape is formed in the container of FIG. 10, and the coffee is dried. Any method will be adapted.

When the above processes are performed, water is slightly sprayed before the extract liquid is inserted into the container for thereby easily taking out the coffee after it is dried.

FIGS. 5 through 9 and FIG. 14 are views of the frozen coffee fabrication processes.

FIG. 10 is a view of a concave container used when fabricating the coffee. There is a slightly protruded part in the container for thereby preventing the coffee from being falling down. The above process is adapted when the coffee liquid is inserted into the center 1 in a flat shape and is dried in a vacuum state and is taken out.

Since the coffee liquid is not well applied, namely, it is sticky, so the above processes are performed in a state that the coffee liquid is slightly frozen.

The shape of the coffee is pressed using a press machine, and the coffee could be pressed using a seal of FIG. 15 for a certain pattern for thereby fabricating a beautiful shape of coffee. When the seal is not used, the pattern could be inputted into the bottom of the container of FIG. 10.

FIG. 11 is a view of an outer container used when forming a 3D structure of FIG. 4. The smaller container of FIG. 12 is a container inserted into the larger container of FIG. 11 for thereby uniformly applying the coffee liquid.

As shown in FIG. 12, the coffee liquid is inserted into the large container of FIG. 11, and the coffee extract liquid is uniformly applied.

FIG. 13 is a view of a structure that the coffee mold is placed on the frozen coffee before it is pressed, and the flat coffee except for the structure may be made in various shapes.

FIG. 14 is a view of a container for making a certain structure of coffee. As shown therein, a certain step is formed in an edge portion of the bottom for preventing a falling of the coffee. The heat-shaped structure has a certain height. A certain space is formed in the lower and upper sides of the structure (D) in which multiple heart-shaped structures are placed thereon. When using the same, the coffee extract liquid is inserted into the container and is slightly frozen for thereby preventing a falling of the coffee. The structure of FIG. 14 is taken out except for the frozen coffee. The resultant structure is dried in the drier or the other one could be left in the structure of FIG. 13 and could be dried.

FIG. 16 is a view of a structure when the frozen coffee is pressed with a heavy member using a press machine or other device. As shown therein, the frozen coffee 8 is provided in the lower most portion, and the mold 9 is provided thereon, and then the press machine 10 or other heavy device is placed thereon.

### INDUSTRIAL APPLICABILITY

In the case of the conventional instant coffee, it is impossible to feel perfume and shape, namely, there is not beauty feeling. However, in the present invention, when melting the coffee according to the present invention in water, it is possible to feel comfort and beauty.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A method and pattern structure by which various kinds of patterns characterized in that a certain amount of coffee is parched at a temperature of 180° C. through 200° C. for 15 minutes, and the coffee is ground well, and fine coffee powder is mixed with hot water at a ratio of 1:4 (coffee:water), and is evaporated in a vacuum evaporator for 30 minutes. At this time, coffee perfume may be extracted in a condenser (it is also extracted in an evaporator and a drier). When the extract coffee is decreased to ⅔ in volume and is got to sticky, in the case of a plane coffee shape of FIGS. 5 through 9, the extract coffee is inserted into a wide and flat container and is frozen, and a shaped coffee is taken out of the container and is pressed by a mold, and a plurality of frozen coffee sheets are pressed in a certain shape, and is frozen at a temperature under zero of 40° C. for 10 minutes and is evaporated in a vacuum drier, and then the frozen coffee is pressed using a press machine and is taken out of the container and is evaporated, and here there are two steps of which in one step the coffee is inserted into the container and then is evaporated, and in the other step the coffee is pressed in a certain shape using a mold, and then it is dried, and when the frozen coffee is dried in the drier, a small weak fire is applied thereto and is dried in a vacuum state under a pressure of 80%, and the instant coffee is finished, so that it is possible to fabricate the coffee in a shape of coffee grain, and the shapes of FIGS. 3 through 9 and FIG. 14 are adapted for thereby finishing a coffee or instant coffee, and in the fabrication of the coffee, the coffee is dried in a vacuum container during the drying step, and in a fabrication of a 3D coffee of FIG. 4, a coffee extract liquid is inserted into an outer structure of FIG. 11, and it is shaped to a smaller structure of FIG. 12 and is dried (or it is performed in a frozen state), and a previously made coffee powder grain is inserted into the outer structure of FIG. 11, and a previously made lid of FIG. 6 is covered for thereby finishing a 3D coffee structure, and a sugar liquid or compressed sugar may be inserted between the outer structure of FIG. 11 and an inner structure of FIG. 11 for maintaining a coffee shape, and in the above method, the fabrication step is the same as in the plane structure, but the methods that the 3D container is used and the coffee powder is inserted into the groove, and the lid is covered, are different, and a certain device except for the press machine used in the coffee fabrication step may be used; and the coffee may be formed in various shapes, and containers and molds are various, and the methods for utilizing the containers may be various, and in the fabrication process of the coffee, it is possible to adjust a mixing ratio of water and coffee, the size of coffee powder, a time and pressure for evaporating coffee in evaporator and drier, a time and temperature for parching coffee, a temperature and time of a freezer, a concentration and ratio of a coffee extract, an amount of moisture of coffee remained when finishing the same, a temperature and pressure for evaporating coffee, and a container utilizing method.

2. The structure of claim 1, wherein various shapes except for the shapes of FIGS. 3 through 9 and FIG. 14 irrespective of the fabrication process are adapted to coffee grain.

3. The structure of claim 1, wherein various shapes except for the shapes of the containers of FIGS. 10, 11, 14 and 15 are adapted, and various shapes are adapted.

4. The structure of claim 1, wherein the coffee is fabricated by inserting the same into the container and freezing the same, and a certain fabrication process is performed, and the finished coffee is taken out of the containers of FIGS. 11, 12 and 14.

5. The structure of claim 1, wherein milk, sugar, cream or desired item is mixed with the coffee powder.

6. The structure of claim 1, wherein the shape of the coffee is 3D, plane shape, and streamline shape.

7. The structure of claim 1, wherein when pressing the frozen coffee in various shapes, a plurality of frozen coffee sheets are overlapped as shown in FIG. 16, and a plurality of frozen coffee sheets are attached to a plurality of containers as shown in FIG. 14.
